(19) United States
(12) Patent Application Publication
(10) Pub. No.: US 2002/0002040 A1
(43) Pub. Date: Jan. 3, 2002

(54) Method and apparatus for interfacing RF signals to medium voltage power lines

(76) Inventors: Paul A. Kline, Gaithersburg, MD (US); Sergey L. Dickey, Fairfax, VA (US)

Correspondence Address: MICHAEL D. STEIN, WOODCOCK WASHBURN KURTZ MACKIEWICZ & NORRIS LLP, ONE LIBERTY PLACE - 46TH FLOOR, PHILADELPHIA, PA, 19103, US

(21) Appl. No.: 09/837,972

(22) Filed: Apr. 19, 2001

Related U.S. Application Data
(60) Provisional application No. 60/198,306, filed on Apr. 19, 2000.

(51) Int. Cl. H04M 9/00

(52) U.S. Cl. 455/402; 455/14; 455/41

(57) ABSTRACT

RF digital information signals are interfaced with a medium voltage power line data channel. An interface circuit connects between the medium voltage and low voltage sides of a step-down power transformer. The interface circuit includes a metal oxide arrestor (MOV) and an opto-coupler. The MOV provides the needed capacitance and voltage rating without the bulk of a capacitor having similar capacitance and voltage rating. The opto-coupler provides an added margin of safety for coupling communications data while isolating the medium voltage power from the low voltage side of the transformer.

### CROSS REFERENCE TO RELATED APPLICATIONS

This application claims priority under 35 U.S.C. § 119(e) from provisional application No. 60/198,306, filed Apr. 19, 2000. The 60/198,306 provisional application is incorporated by reference herein, in its entirety, for all purposes.

### INTRODUCTION

The present invention relates generally to the field of digital communications. More particularly, the present invention relates to communication of digital signals, including information and control signals, via power lines.

### BACKGROUND OF THE INVENTION

Referring to FIG. 1, a typical electric power distribution architecture is illustrated. The configuration shown has a transformer 10 that steps medium voltage (tens of thousands of volts) power down to low voltage power (a few hundred volts AC, typically 100 to 240 VAC). The low voltage (LV) power is fed to several homes 20. Using this architecture for a power line communications system, the medium voltage (MV) line can be used to transfer data to and from the LV lines.

Since the MV line is typically rated at a few tens of kilovolts, interfacing to the MV line can prove to be costly, size prohibitive, and pose safety hazards. For example, an RF (radio frequency) signal is typically used in a powerline communications system as a carrier for digital information or control signals. In order to couple such an RF signal into a wire with large voltage at low frequencies (50-60 Hz), the solution would appear to call for a high pass filter that can withstand high voltage (i.e., the voltage level of the MV line). The high pass filter is used to prevent the low frequency (typically in the range of 50-60 Hz) power line voltage from being coupled into the RF transmitter and receiver circuitry, referred to below as the “communications device”. A capacitor could provide such a filter, however such a filter capacitor would need to be able to withstand tens of kilovolts carried on the MV line. A filter capacitor according such requirements is expensive and physically large.

Thus, what is needed is a low cost, small form factor, safe scheme for interfacing RF signals to a MV power line.

### SUMMARY OF THE INVENTION

The present invention provides a method and apparatus of interfacing a high frequency signal in a power line communications system. The present invention is especially useful in, although by no means limited to, applications in which an RF signal is coupled to and from a medium voltage power line, such as a power distribution or transmission line. There are two types of MV distribution systems that power utilities use: (1) aerial and (2) underground. Presently preferred embodiments of the invention work for both distribution system types.

A presently preferred implementation of the invention employs a metal oxide varistor (MOV) as an element of a high pass filter to substantially attenuate the low frequency power line voltage and current waveforms, so as to prevent them from damaging the communications device used to transmit and receive the digital signal. Other aspects of presently preferred embodiments of the invention are described below.

### BRIEF DESCRIPTION OF THE DRAWINGS

Additional objects and advantages of the present invention will be apparent in the following detailed description read in conjunction with the accompanying drawing figures.

FIG. 1 illustrates a conceptual view of a typical electric power distribution topology.

FIG. 2 illustrates a schematic block diagram of an interface circuit for a medium voltage power line according to an embodiment of the present invention.

FIG. 3 illustrates a graph of the transfer function for a front-end circuit embodied according to one embodiment of the present invention.

FIG. 4 illustrates a schematic diagram of an interface circuit front-end portion, according to an alternate embodiment of the present invention, with a ferrite bead to ground.

FIG. 5 illustrates a schematic diagram of an interface circuit front-end portion, according to another alternate embodiment of the present invention, with a quarter wave length tap.

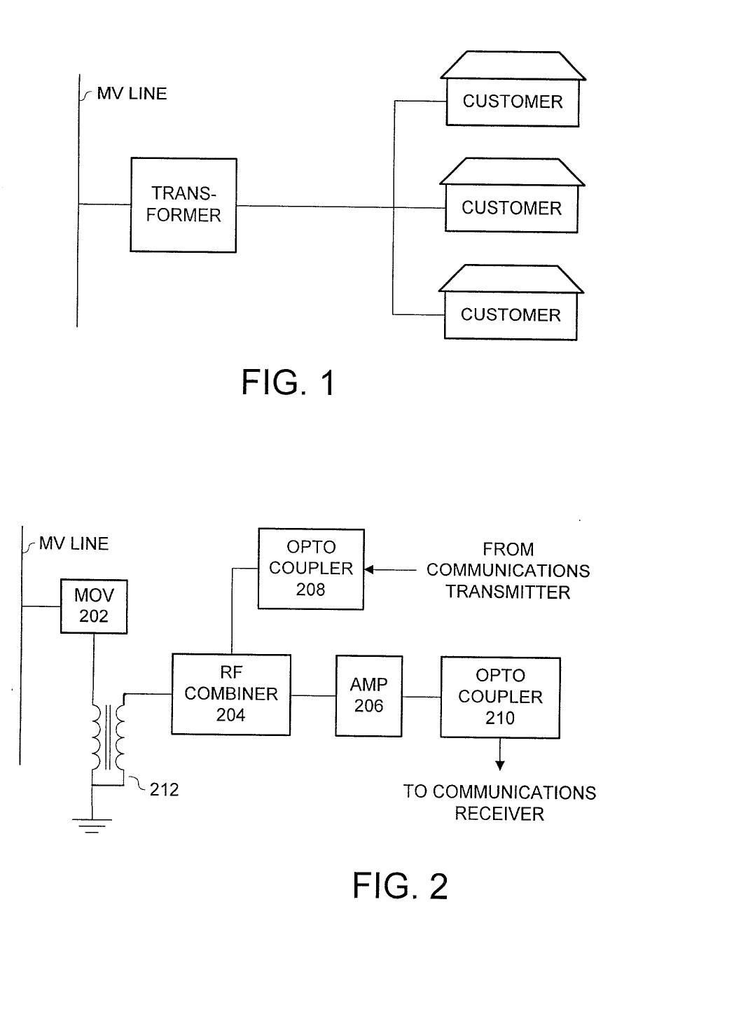

### DETAILED DESCRIPTION OF PREFERRED EMBODIMENTS

The present invention may be advantageously embodied as an interface circuit for interfacing transmitted and received radio frequency communications signals with a medium voltage power line. A preferred embodiment of the interface circuit has a medium voltage node that is adapted for connection to the medium voltage power line, a reactive element adapted to be connected to ground, and a metal oxide varistor connected between the medium voltage node and the reactive element. A first opto coupler couples into the interface circuit the transmitted radio frequency communications signals to be interfaced via the medium voltage node, and a second opto coupler couples out of the interface circuit the received radio frequency communications signals interfaced via the medium voltage node. A radio frequency combiner is connected to the reactive element. The radio frequency combiner is also connected to the first opto coupler so as to make the transmitted radio frequency communication signals available to the medium voltage node via the metal oxide varistor. The radio frequency combiner, which is optional and may be used in situations in which the transmit and receive signals are coupled to/from the MV line via a common interface, is further connected to the second opto coupler so as to make the received radio frequency communications signals available from the medium voltage node via the metal oxide varistor.

In order to couple an RF signal into a wire with high voltage at low frequencies (50-60 Hz), essentially a high pass filter that can withstand high voltage may be used. As mentioned above, a capacitor that can operate as such a filter and withstand tens of kilovolts is prohibitively expensive and physically large.

One device that provides capacitance (other than a capacitor) in a communications application is a MOV. A column of MOVs can withstand up to 80 kV peak, and provide about 10 pF of capacitance. The physical size is acceptable as well. An additional feature of using MOVs is that they provide surge protection. As MV lines are subject to lightning strikes, high energy surges, switching transients, etc., this increased safety feature is important. MOV products fitting these requirements (e.g., MOV gapped elbow arrester 235-55) are available from Cooper Power Systems, Inc. of Pittsburgh, Pa.

An opto-coupler is used for additional safety, thus electrically isolating the MV circuitry from the communications equipment via light.

Referring to FIG. 2, an exemplary embodiment for constructing such an interface circuit is illustrated. The MOV 202 is connected to the MV line and to the primary windings of a transformer 212. An RF signal on the MV line will flow through the MOV 202 and will be present on the secondary of the transformer 212. The MOV 202 is an open circuit for the medium voltage power (since the power line voltage is less than the MOV's conduction voltage). Preferably, the transformer 212 is a toroidal transformer with a few windings of the MOV 202 ground wire on the primary and a few windings of magnetic wire on the secondary. The RF combiner 204 combines the receive and transmit signals from the communications device. The amplifier 206 on the receive side increases receiver sensitivity but is an optional feature that is not necessary for all applications. The opto-couplers 208, 210 decouple the communications device from the medium voltage line circuitry (a desired safety feature); this too is an optional feature that is not necessary for all applications.

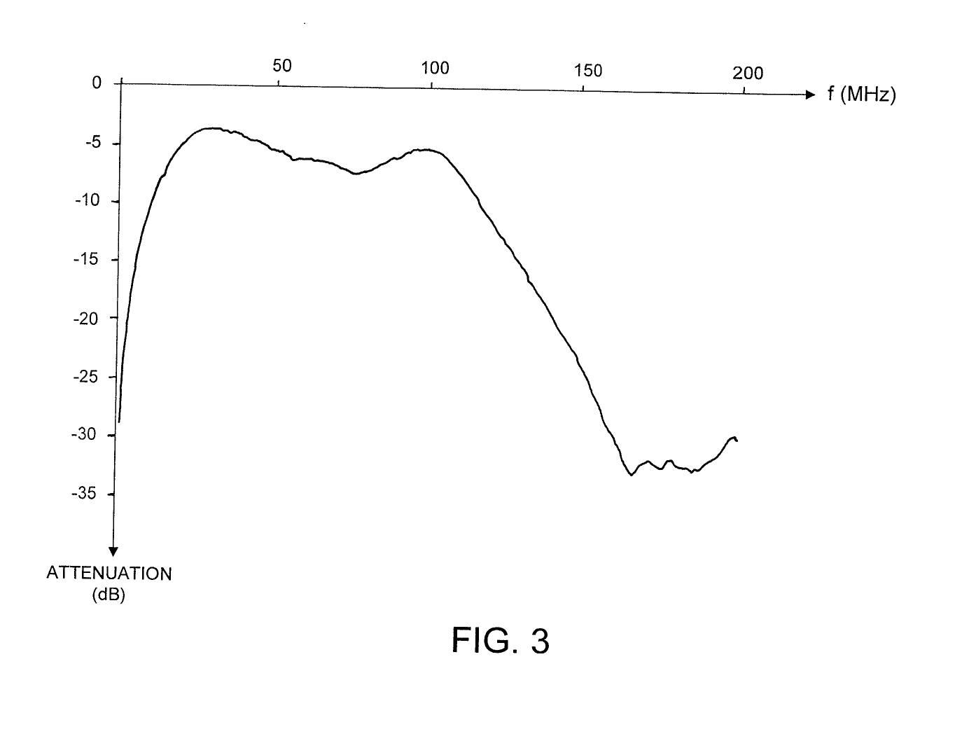

Referring to FIG. 3, the transfer function for an exemplary front end circuit is illustrated. Frequency (in MHz) is represented along the horizontal-axis, and attenuation (in dB) is represented along the vertical-axis. A broad band of relatively low attenuation is evident from about 15 MHz to about 115 MHz. Low (i.e., power distribution) frequencies, such as those in the 50-60 Hz band, are heavily attenuated.

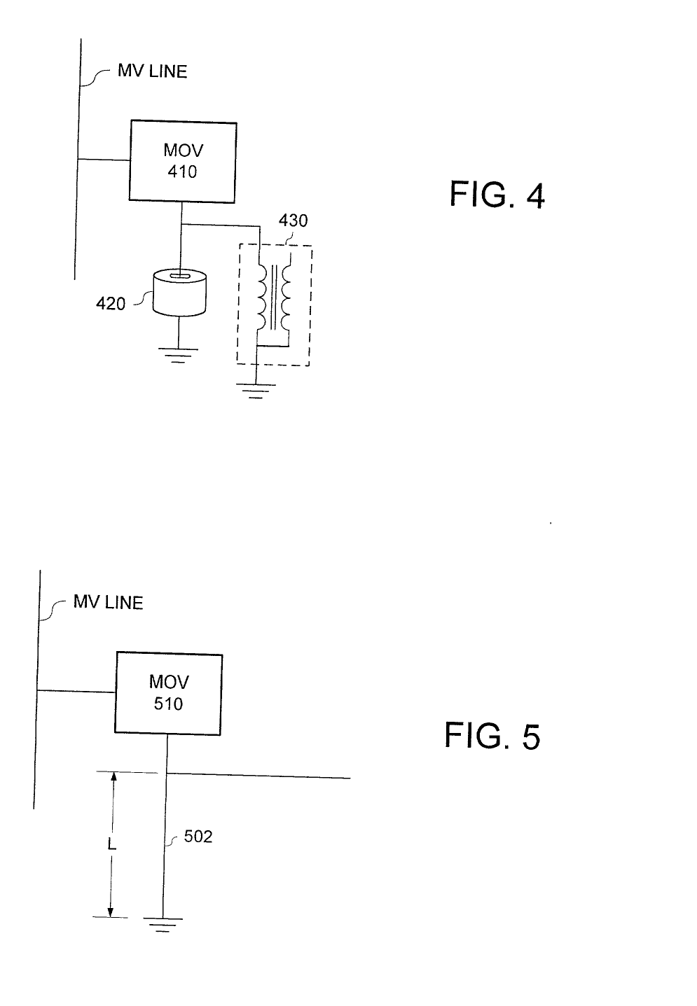

Referring to FIG. 4, an interface circuit front-end portion according to an alternate embodiment is illustrated. In this embodiment, a ferrite bead 420 is placed between the MOV 410 and ground to choke the RF signal from being grounded. The ferrite bead 420 is connected in parallel with the transformer 430.

Referring to FIG. 5, an interface circuit front-end portion according to another alternate embodiment is illustrated. The transformer shown in the previously described embodiments is omitted and its functionality is replaced by feeding the ground line 502 between the MOV 510 and ground at an interval L that is a quarter wavelength (λ/4), measured at the carrier frequency, from the ground point. Installation according to this alternate embodiment may be tricky, but has the advantage of being particularly elegant.

The present invention has been described in terms of preferred embodiments, however, it will be appreciated that various modifications and improvements may be made to the described embodiments without departing from the scope of the invention.

What is claimed is:

1. An interface circuit for interfacing radio frequency communications signals with a medium voltage power line, the interface circuit comprising:
a medium voltage node adapted for connection to the medium voltage power line;
a reactive element adapted for connection to a common potential;
a metal oxide varistor connected between the medium voltage node and the reactive element, wherein the radio frequency communications signals are interfaced to the medium voltage node via the metal oxide varistor.

2. The interface circuit for interfacing, radio frequency communications signals with a medium voltage power line of claim 1, wherein the reactive element comprises: a transformer.

3. The interface circuit for interfacing radio frequency communications signals with a medium voltage power line of claim 1, wherein the reactive element comprises:
a transformer, and
a conductive line coupled through a ferrite bead;
wherein the transformer and the conductive line are connected in parallel with one another.

4. The interface circuit for interfacing radio frequency communications signals with a medium voltage power line of claim 1, wherein the radio frequency communications signals include transmitted signals, the interface circuit further comprising:
a first opto coupler adapted to couple in to the interface circuit the transmitted radio frequency communications signals to be interfaced via the medium voltage node.

5. The interface circuit for interfacing radio frequency communications signals with a medium voltage power line of claim 4, wherein the radio frequency communications signals include received signals, the interface circuit further comprising:
a second opto coupler adapted to couple out of the interface circuit the received radio frequency communications signals interfaced via the medium voltage node; and
a radio frequency combiner that is connected to the reactive element, and connected to the first opto coupler so as to make the transmitted radio frequency communication signals available to the medium voltage node via the metal oxide varistor, and connected to the second opto coupler so as to make the received radio frequency communications signals available from the medium voltage node via the metal oxide varistor.

6. The interface circuit for interfacing radio frequency communications signals with a medium voltage power line of claim 5, further comprising:
an amplifier connected between the radio frequency combiner and the second opto coupler so as to provide amplification of the received radio frequency communications signals.

7. The interface circuit for interfacing radio frequency communications signals with a medium voltage power line of claim 1, wherein the radio frequency communications signals include received signals, the interface circuit further comprising:
an opto coupler adapted to couple out of the interface circuit the received radio frequency communications signals interfaced via the medium voltage node.

8. The interface circuit for interfacing radio frequency communications signals with a medium voltage power line of claim 1, wherein the common potential comprises ground.

9. An interface circuit for interfacing radio frequency communications signals with a medium voltage power line, the interface circuit comprising:
a medium voltage node adapted for connection to the medium voltage power line;
a conductive line having a selected length and being adapted for connection to a common potential, the selected length being one quarter of the wavelength of the radio frequency communications signals; and
a metal oxide varistor connected between the medium voltage node and the conductive line, wherein the radio frequency communications signals are interfaced to the medium voltage node via the metal oxide varistor.

10. The interface circuit for interfacing radio frequency communications signals with a medium voltage power line of claim 9, wherein the radio frequency communications signals include transmitted signals, the interface circuit further comprising:
a first opto coupler adapted to couple in to the interface circuit the transmitted radio frequency communications signals to be interfaced via the medium voltage node.

11. The interface circuit for interfacing radio frequency communications signals with a medium voltage power line of claim 10, wherein the radio frequency communications signals include received signals, the interface circuit further comprising:
a second opto coupler adapted to couple out of the interface circuit the received radio frequency communications signals interfaced via the medium voltage node; and
a radio frequency combiner that is connected to the reactive element, and connected to the first opto coupler so as to make the transmitted radio frequency communication signals available to the medium voltage node via the metal oxide varistor, and connected to the second opto coupler so as to make the received radio frequency communications signals available from the medium voltage node via the metal oxide varistor.

12. The interface circuit for interfacing radio frequency communications signals with a medium voltage power line of claim 11, further comprising:
an amplifier connected between the radio frequency combiner and the second opto coupler so as to provide amplification of the received radio frequency communications signals.

13. The interface circuit for interfacing radio frequency communications signals with a medium voltage power line of claim 9, wherein the radio frequency communications signals include received signals, the interface circuit further comprising:
an opto coupler adapted to couple out of the interface circuit the received radio frequency communications signals interfaced via the medium voltage node.

14. The interface circuit for interfacing radio frequency communications signals with a medium voltage power line of claim 9, wherein the common potential comprises ground.

15. A method for receiving a digital signal from a power line carrying both the digital signal and a powerline voltage waveform, wherein the digital signal is modulated by an RF carrier and the powerline voltage waveform is in the 50-60 Hz band, comprising receiving the digital signal through a high pass filter while blocking or attenuating the powerline voltage, wherein the high pass filter comprises a metal oxide varistor (MOV).

16. The method for receiving a digital signal from a power line of claim 15, wherein the high pass filter further comprises a reactive element connected between the MOV and a common potential.

17. The method for receiving a digital signal from a power line of claim 15, wherein the high pass filter further comprises a selected length conductive line connected between the MOV and a common potential, the selected length being one quarter of the wavelength of the RF carrier.
